(19) United States
(12) Patent Application Publication
(10) Pub. No.: US 2025/0316248 A1
(43) Pub. Date: Oct. 9, 2025

(54) IMAGE DISPLAY DEVICE HAVING PHYSIOLOGICAL VARIABLE-BASED ADAPTIVE BRIGHTNESS

(71) Applicant: SAFRAN ELECTRONICS & DEFENSE, Paris (FR)

(72) Inventors: Bastien DELOISON, MOISSY-CRAMAYEL (FR); Vincent MARIE, MOISSY-CRAMAYEL (FR)

(73) Assignee: SAFRAN ELECTRONICS & DEFENSE, Paris (FR)

(21) Appl. No.: 18/866,891

(22) PCT Filed: May 12, 2023
(86) PCT No.: PCT/FR2023/050689

§ 371 Date: Nov. 18, 2024

(30) Foreign Application Priority Data
May 18, 2022 (FR) FR2204750

(51) Int. Cl. G09G 5/10; G02B 27/00; G06F 3/01; G06T 7/62; H04N 23/21; H04N 23/56; H04N 23/74

(52) U.S. Cl. CPC G09G 5/10; G02B 27/0093; G06F 3/013; G06T 7/62; H04N 23/21; H04N 23/56; H04N 23/74; G06T 2207/10048; G06T 2207/30201; G09G 2320/0626; G09G 2320/0666; G09G 2354/00; G09G 2360/144

(57) ABSTRACT

A device for displaying images having adaptive brightness includes an eyepiece configured to accommodate at least one eye of a user, and a digital display in the visible range positioned behind the eyepiece. The display device further includes an illuminator configured to illuminate the eye of the user accommodated by the eyepiece, an image sensor configured to collect an image of the eye of the user accommodated by the eyepiece, and a system for the automatic control of brightness of the digital display on the basis of at least one physiological variable resulting from the image of the eye of the user.

### TECHNICAL FIELD

This invention relates to information viewing and observation equipment.

In particular, the present invention relates to immersive observation equipment and display devices intended for use with a user's eye positioned in proximity to said equipment. The field more particularly relates to the light adaptation of a display screen of immersive observation equipment.

Generally, the invention applies to any display screen where light intensity can be varied to enhance user comfort and immersion.

### PRIOR ART

Some man-machine interfaces include a digital screen and/or a projector, observable by a user's eye positioned in close proximity to said screen, for example through an eyepiece of the eyecup type and/or an ocular allowing observation in a dark environment around the eye. These man-machine interfaces can be found, for example, in binoculars for short- or long-range vision or observation, in a digital camera, an augmented reality mask or any other type of viewfinder or display comprising a digital screen and/or a projector.

Adjusting brightness in such digital displays is important because the user may be required to be in a bright outdoor environment, for example in broad daylight, or conversely very dark, for example in the dark of night, while still being required to look at the digital display through the eyepiece from time to time. Relative brightness of the screen in relation to the external environment then needs to be adapted so as not to disturb the user's vision when their gaze transitions from observing the external environment to observing the screen, and vice versa. In other words, the transition needs to be made in such a way that the user is not dazzled or, conversely, can see the information displayed and/or the external environment when it is dark.

There are systems that automatically control the light intensity, in other words brightness, of a digital screen, for example of a mobile phone. Known systems contain, for example, a sensor for the brightness of the external environment, which can be used to adapt the brightness of the screen on the basis of the external brightness.

However, a brightness sensor can be hidden and covered so that it returns incorrect information about the brightness of the external environment. In addition, a brightness sensor has an orientation and/or position that does not necessarily correspond to the direction of the user's gaze: this may especially be the case for medium- and/or long-distance aiming systems. In addition, systems could acquire brightness information from a particular dark zone whereas the rest of the scene is very bright.

The brightness sensor can also be subject to saturation effects or sensitivity limitations in very bright or dimly lit external environments.

### DISCLOSURE OF THE INVENTION

The purpose of the present invention is therefore to overcome the aforementioned draw backs and to provide a display device with reliable and improved brightness adaptation.

The object of the present invention is an image display device with adaptive brightness comprising an eyepiece intended to accommodate at least one eye of a user, and a digital display in the visible range positioned behind the eyepiece, the device comprising an illuminator intended to illuminate the eye of the user accommodated by the eyepiece, an image sensor intended to collect an image of the user's eye accommodated by the eyepiece, and a system for the automatic control of the brightness of the digital display on the basis of at least one physiological variable resulting from the image of the user's eye.

The illuminator operates in the visible or infrared range, for example.

The display device thus makes it possible to adapt brightness of the digital display on the basis of the user's physiological indicators and thus to meet the user's expectations as closely as possible. The display device also enables smooth transitions in brightness depending on the course of physiological variables in order to reduce visual fatigue and stress.

In one embodiment, the automatic control system comprises a module for detecting and measuring pupil diameter of the user's eye on an image of the user's eye, and/or a module for detecting condition and stress level of the user comprising a module for recovering the user's temperature and/or a module for recovering the user's heart rate, the at least one physiological variable being selected from the pupil diameter of the eye, temperature and heart rate of the user.

In one particular embodiment, the device comprises an ambient brightness sensor and/or a lighting ambience sensor and/or a user control interface so that the system for automatically controlling brightness of the digital display also uses the ambient brightness and/or the lighting ambience and/or a user control to automatically control said brightness of the digital display.

Advantageously, the illuminator and image sensor operate in the near infrared spectral range.

Advantageously, the device comprises an optical system comprising a set of focusing and/or collimating lenses for guiding light from the digital display and from the illuminator to the user's eye and from the user's eye to the image sensor, the optical system also comprising a dichroic filter.

Advantageously, the optical system comprises a free-form optical element comprising the dichroic filter and the set of lenses.

In one embodiment, the device comprises a user eye proximity sensor for operating the image display device when the user's eye is in proximity.

Advantageously, the brightness automatic control system further comprises a colourimetry control module.

Advantageously, the automatic control system comprises a module for controlling operating parameters of the illuminator and the image sensor on the basis of the image acquired from the user's eye.

Another object of the present invention is a method for adapting brightness of a display device as hereinbefore defined, the method comprising the following steps:
Acquiring an image of the user's eye;
Measuring the initial pupil diameter of the user's eye from the image of the user's eye and defining an initial brightness setpoint for the digital display;
Adjusting brightness of the digital display with the initial brightness setpoint;
Acquiring a series of images of the user's eye;
Measuring the pupil diameter of the user's eye for each image of the series of images acquired; and
Adjusting brightness of the digital display on the basis of the course of the measurement of the pupil diameter of the user's eye.

### BRIEF DESCRIPTION OF THE DRAWINGS

Other purposes, characteristics and advantages of the invention will become apparent upon reading the following description, given merely as a non-limiting example, and made with reference to the appended drawings, wherein:

FIG. 1 is a schematic view of an image display device having adaptive brightness according to the invention;

FIG. 2 is a schematic view of an optical system of an image display device having adaptive brightness according to the invention;

FIG. 3 is a schematic view of a first alternative of the optical system of FIG. 2;

FIG. 4 is a schematic view of a second alternative of the optical system of FIG. 2;

FIG. 5 is a schematic view of a third alternative of the optical system of FIG. 2;

FIG. 6 and

FIG. 7 and

FIG. 8 and

FIG. 9 are brightness and pupil diameter profiles during operation of the display device according to the invention; and

FIG. 10 is a schematic representation of a brightness adaptation method for a display device according to the invention.

### DETAILED DISCLOSURE OF AT LEAST ONE EMBODIMENT

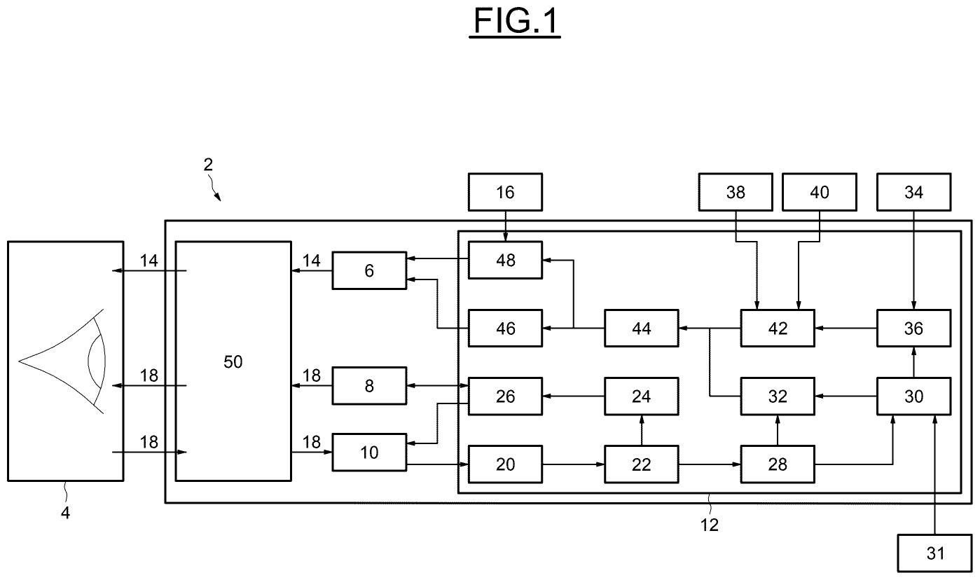

An image display device 2 having adaptive brightness is schematically represented in FIG. 1.

The display device 2 is intended to provide a user with an immersive display. In other words, the user's eye 4 is intended to be in proximity to the display device 2, which is of the “near-eye” type. In particular, the display device 2 is a photographic apparatus, or binoculars, or a monocular, or a periscope, or a virtual/augmented reality mask or any other type of viewfinder or display.

The display device 2 comprises an eyecup-type eyepiece (not represented) intended to accommodate the user's eye or eyes. The eyepiece is, for example, a piece of plastic or silicone, or a simple location in which the user's eye has to be positioned in order to observe in the display device. The purpose of the eyepiece is to enable observation in the display device isolated from brightness in the external environment.

The display device 2 optionally comprises a proximity sensor (not represented) for the user's eye 4. Thus, the display device 2 is only operated when the user's eye 4 is positioned in proximity to the display device 2, preferably positioned against the eyepiece.

The display device 2 also comprises a digital display 6, an illuminator 8, an image sensor 10 and an automatic control system 12 for the brightness of the digital display 6.

The digital display 6 emits radiation 14 in the visible range and is positioned behind the eyepiece, so that the user's eye 4 can see the digital display 6 inside the display device 2 when their eye 4 is positioned against the eyepiece. For example, the digital display 6 is a microdisplay for displaying and transmitting information to the user. This is for example a screen or a projector, using OLED technology for example. The display device 2 also comprises a module 16 for inputting a video signal from a video source that is external and/or internal to the input module 16, the input module 16 being connected to the digital display 6 for displaying an image or video of the video signal to the user. By video signal, it is also meant any visual information such as symbols and/or text.

The illuminator 8 is intended to illuminate the user's eye 4 when it is accommodated by the eyepiece. The illuminator 8 operates by emitting radiation 18 in the infrared spectral range, especially in the near infrared wavelengths, for example between 0.7 and 1.6 micrometre in wavelength.

The image sensor 10 is intended to collect an image of the user's eye 4 when the eye 4 is placed against the eyepiece and illuminated by the illuminator 8. The image sensor 10 operates at least at the same wavelengths as the illuminator 8. Thus, when the illuminator 8 lights the user's eye 4 with infrared radiation 18, the user is not dazzled and the image sensor 10 recovers an infrared image of the user's eye 4 by virtue of the illumination performed. In addition, the eyepiece prevents the image sensor 10 from being able to capture light from the external environment.

The automatic control system 12 makes it possible to automatically adjust brightness of the digital display 6 on the basis of at least one physiological variable, preferably resulting from the image of the user's eye. The physiological variable is, for example, the pupil diameter of the user's eye 4, the pupil diameter of an eye being a parameter varying as a function of the brightness entering said eye.

The automatic control system 12 comprises an image sensing module 20 and a module 22 for automatically analysing quality of the image output from the image sensing module 20.

The image sensing module 20 allows acquisition and optionally recording of an image of the user's eye 4 in conjunction with the image sensor 10.

In particular, the analysis module 22 makes it possible to check that the image quality of the eye 4 is sufficient to measure the pupil diameter, for example.

To correct the image quality output from the image sensor 10, the automatic control system 12 comprises a compensation strategy module 24 and a module 26 for controlling operating parameters of the illuminator 8 and of the image sensor 10. The compensation strategy module 24 automatically selects which parameters of the illuminator 8 and image sensor 10 to modify on the basis of the quality of the image acquired from the user's eye 4. The parameters to be modified are transmitted to the control module 26 of the operating parameters of the illuminator 8 and the image sensor 10 in order to modify both lighting of the illuminator 8 and acquisition parameters of the image sensor 10. For example, the control module 26 can increase brightness of the illuminator 8 and decrease the integration time of the image sensor 10 in order to reduce noise in the image of the eye 4.

In the embodiment illustrated in FIG. 1, the automatic control system 12 comprises a module for detecting and measuring 28 the pupil diameter of the user's eye 4 on an image of the user's eye 4 acquired by the image sensor 10.

Alternatively or additionally, the automatic control system 12 comprises a module 30 for detecting condition and stress level of the user. The module 30 for detecting condition and stress level of the user comprises, for example, a module for recovering the user's temperature from a temperature sensor, for example included in a module 31 external to the display device 2, and/or comprises a module for recovering the user's heart rate from a heart rate sensor, for example included in the module 31 external to the display device 2. Module 30 can also receive as an input parameters for fluctuations in the pupil diameter of the eye 4, resulting from the detection and measurement module 28, and these parameters can also be a stress indicator. Thus, in a stressed condition measured by heart rate, the user may need to be given information which is highlighted more strongly by the digital display 6 with greater brightness.

The automatic control system 12 thus uses one or more physiological variables such as pupil diameter, temperature and the user's heart rate to automatically adapt brightness on the digital display 6.

The automatic control system 12 further comprises a module for applying theoretical heuristics 32 on the basis of physiological variables. This module for applying theoretical heuristics 32 makes it possible to define, for example using tables or computer learning, brightness laws applicable according to the values of the physiological variables.

Optionally, the display device 2 comprises a user control interface 34 so as to enable the user to give instructions, for example for brightness, manually. The automatic control system 12 further comprises a module 36 for collecting user commands resulting from the control interface 34. This collection module 36 also comprises a memory comprising the history of the user's actions and conditions. Thus, the automatic control system 12 can use a user command and/or condition to automatically control brightness of the digital display 6. Furthermore, it can also use the history of these commands and/or conditions to determine, for example by computer learning, a possible automatic control of brightness for the digital display 6.

The display device 2 optionally comprises an ambient brightness sensor 38, in other words an external environment brightness sensor, and/or a lighting ambient sensor 40. The ambient brightness sensor 38 may comprise an LDR (Light Dependent Resistor) or comprise an image sensor in the visible range and calibration and correspondence data between an integration time and the ambient brightness, for example to establish classification by scene type of the external environment.

The lighting ambient sensor 40 makes it possible in particular to measure the colourimetry of the environment external to the display device 2. The lighting ambient sensor 40 comprises, for example, a plurality of detection elements sensitive to distinct wavelengths.

The automatic control system 12 further comprises a module 42 for detecting variation in ambient brightness and/or ambience. In one alternative of the display device 2 comprising a module 36 for collecting user commands, the module 42 for detecting variation in ambient luminance and/or ambience makes it possible, for example, to link a history of ambient luminance and/or ambience to the history of the user's actions and conditions in order to optimise brightness of the display.

The automatic control system 12 comprises a brightness adaptation strategy module 44, a module for controlling brightness 46 of the digital display 6, and optionally a module for controlling colourimetry 48 of the digital display 6. This strategy module 44 compiles the parameters to be taken into account to modify the luminance and/or the colourimetry of the digital display 6 and sends luminance instructions to the luminance control module 46 which influences the luminance of the digital display 6, and optionally to the colourimetry control module 48, which can thus modify the colourimetry of the video signal leaving the input module 16 and transmit this corrected video signal to the digital display 6.

The automatic control loop is then closed by the user who, in response to a variation in brightness on the digital display 6, modifies physiological variables, which are in turn taken into account in the automatic control system 12.

The display device 2 further comprises an optical system 50 comprising a set of focusing and/or collimating lenses 52 for guiding visible light from the digital display 6 to the user's eye 4, for guiding infrared light from the illuminator 8 to the user's eye 4 and from the user's eye 4 to the image sensor 10. Optionally, the optical system 50 comprises a dichroic filter 54.

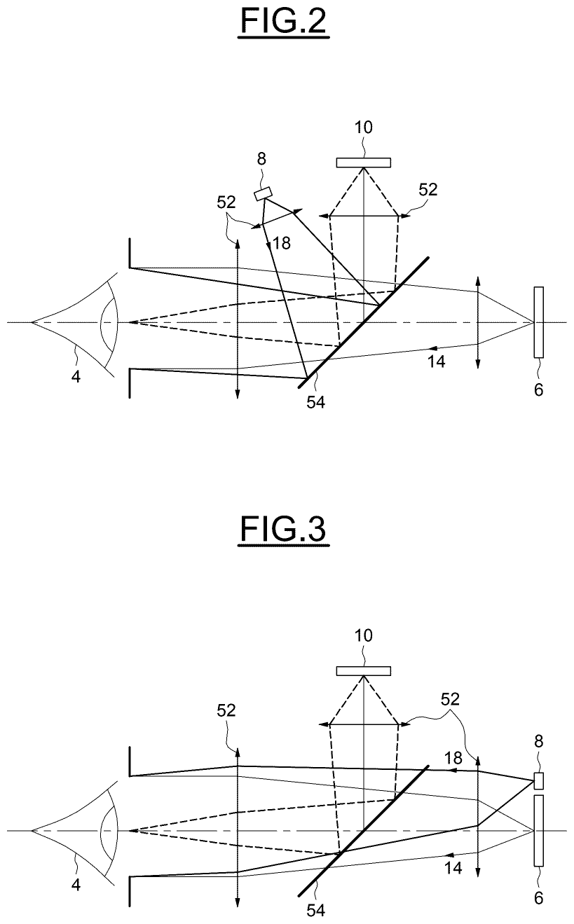

An optical system 50 between a user's eye 4 and a digital display 6, an image sensor 10 and an illuminator 8 has been schematically represented in FIG. 2.

In this embodiment, the dichroic filter 54 reflects infrared radiation 18 and transmits visible radiation 14. The digital display 6 is thus positioned on one side of the dichroic filter 54, while the illuminator 8 and the image sensor 10 are on the other side. This embodiment illustrates direct vision of the digital display 6 by the user.

A first alternative of an optical system 50 between a user's eye 4 and the digital display 6, the image sensor 10 and the illuminator 8 has been schematically represented in FIG. 3.

In this embodiment, the dichroic filter 54 reflects 50% of the infrared radiation and transmits the visible radiation 14 as well as 50% of the infrared radiation 18. The digital display 6 and the illuminator 8 are positioned on one side of the dichroic filter, while the image sensor 10 is on the other side. This embodiment illustrates direct vision by the user of the digital display 6, and more generally of the radiation-emitting functions.

In the embodiments illustrated in FIGS. 2 and 3, the arrangement of the digital display 6, the image sensor 10 and the illuminator 8 on one side and the dichroic filter 54 on the other side can absolutely be reversed on the basis of the transmission and reflection properties of the dichroic filter.

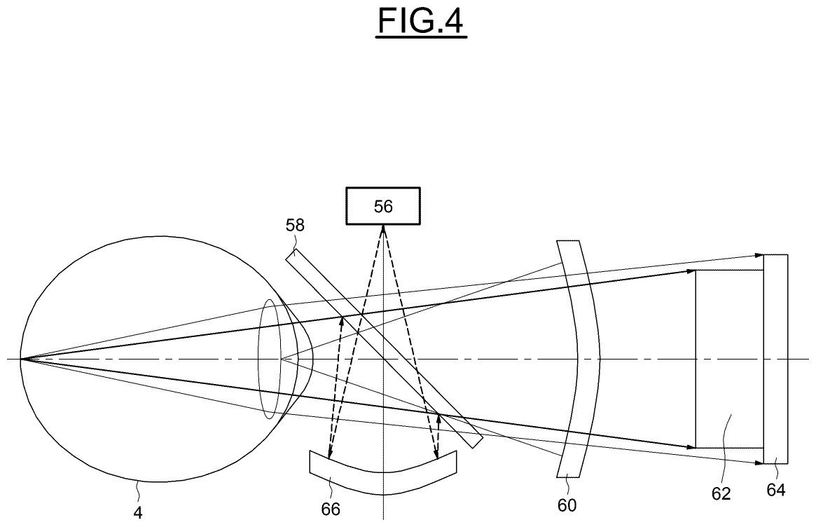

A second alternative of an optical system 50 between a user's eye 4 and the functions of the digital display 6, the image sensor 10 and the illuminator 8 has been schematically represented in FIG. 4. In this alternative, these three functions are performed by one and the same bidirectional component 56. By bidirectional, it is meant that the bidirectional component 56 performs both an image acquisition function with the image sensor 10, and a transmission function with the digital display 6 and the illuminator 8.

In this embodiment, the optical system comprises a semi-reflective plate 58, a first dichroic filter 60 transmitting infrared and reflecting visible light and thus making it possible to collimate and superimpose the display 62 of the digital display on a vision of the external environment 64, and a second dichroic filter 66 transmitting visible light and reflecting infrared so as to focus infrared radiation on the bidirectional component 56 after having lit the eye 4. This embodiment is suitable for making an augmented reality device. In this embodiment, illuminator 8 is optional, as ambient near infrared radiation, in other words radiation from the external environment, can be used to illuminate the eye instead of or in addition to the illuminator 8.

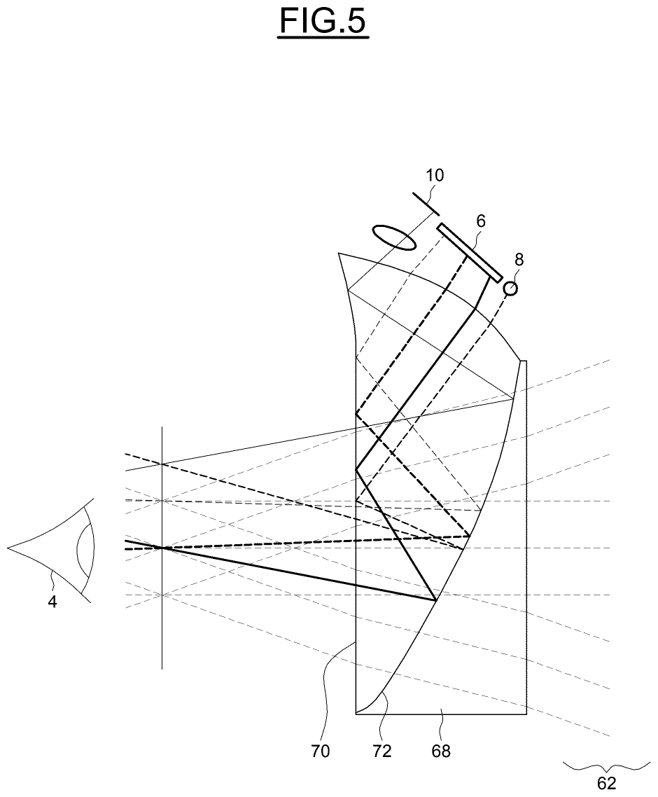

A third alternative of an optical system 50 between a user's eye 4 and the digital display 6, the image sensor 10 and the illuminator 8 has been schematically represented in FIG. 5.

In this alternative, the optical system 50 comprises a free-form optical element 68, in other words one or more surfaces of which may be free-form, having functions of a dichroic filter and a set of lenses. This embodiment is also suitable for making an augmented reality device. In particular, the optical element 68 comprises a first inner surface 70 on which the rays resulting from the illuminator 8 and the digital display 6 are reflected after entering the optical element 68, and a second surface 72 on which they are also reflected before passing through the first surface 70 towards the eye 4, the eye 4 having the sensation, as in the third alternative of FIG. 4, that the display 62 of the digital display 6 is superimposed on the vision of the external environment and/or the vision of another element, for example a panel or a second display. Infrared radiation 18 then travels in the opposite direction to the image sensor 10. In this embodiment, the first surface 70 behaves differently depending on the inclination of the light rays striking it.

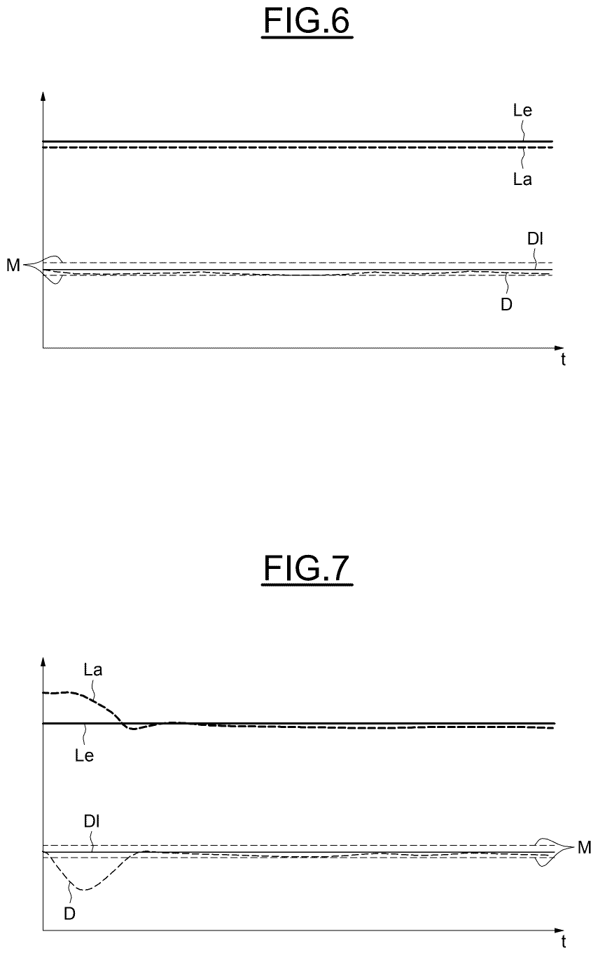

Brightness and pupil diameter profiles during operation of display device 2 as a function of time t have been represented in FIGS. 6, 7, 8 and 9.

The steps of the method for adapting brightness of the display device 2 have also been schematically represented in FIG. 10, the implementation of which has an effect on the course of the profiles of FIGS. 6 to 9.

After the user's eye 4 has been positioned facing the display device, a step 74 of acquiring an image of the user's eye 4 is performed. This step 74 is carried out using the image sensor 10.

Then, a step 75 of measuring the initial pupil diameter of the user's eye 4 is carried out on the basis of the image of the user's eye 4 and an initial brightness setpoint is defined for the digital display 6. The initial diameter is denoted by ID. The initial setpoint is predetermined or calculated on the basis of said initial diameter. Steps 74 and 75 can also be performed with the acquisition of several images of the user's eye 4 when the user positions his/her eye facing the display device 2.

A step 76 of adjusting brightness on the digital display 6 with the initial brightness setpoint is then carried out. The brightness of the digital display 6 is denoted by La.

The brightness La of the digital display 6 then influences the size of the pupil of the user's eye 4 if the brightness of the external environment denoted by Le differs.

The brightness adaptation method then comprises repeating steps 74 to 76 with acquiring a series of images of the user's eye 4, measuring the pupil diameter D of the user's eye 4 for each image of the series of images acquired, and adjusting the brightness La of the digital display 6 on the basis of the course of the measurement of the pupil diameter D of the user's eye 4.

In FIG. 6, brightnesses Le and La are equal, which is why the diameter D varies very little around ID and a tolerance range of plus or minus M. The tolerance range of plus or minus M makes it possible in particular to filter out micro-variations in brightness and avoid discomfort for the user.

In FIG. 7, the user introduces his/her eye 4 into contact with the eyepiece and after the first three steps, the brightness La is greater than the brightness Le. The pupil of eye 4 therefore closes until the display device stabilises its brightness La at the external brightness Le by virtue of studying variations in the pupil diameter D of the user.

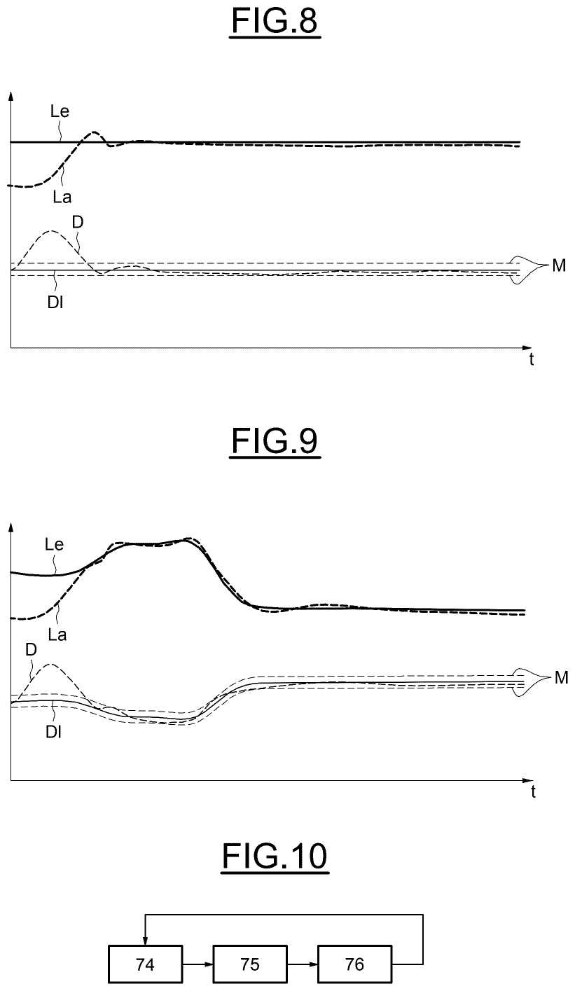

In FIG. 8, the user introduces his/her eye into contact with the eyepiece and after the first three steps, the brightness La is less than the brightness Le. The pupil of the eye 4 therefore opens until the display device 2 stabilises its brightness La at the external brightness Le by virtue of studying variations in the pupil diameter D of the user.

In FIG. 9, an implementation of the method in which the initial diameter ID generating the initial luminance setpoint is modified on the basis of the brightness of the external environment Le has been represented. This mode of implementation is a favoured mode and enables the external brightness and the pupil diameter of the user's eye to be used together to adapt brightness La of the digital display 6 as best as possible. This is an a posteriori adaptation in which if brightness Le varies after the eye 4 is positioned, the display device 2 varies its brightness La to prepare the eye 4 for a higher or lower brightness Le without it being dazzled, or seeing nothing, when it looks away from the display device 2.

More generally, the display device and the brightness adaptation method associated therewith enable brightness of the digital display to be brought into line with brightness of the external environment so that the user can shift from one to the other without experiencing visual fatigue.

1. An image display device having adaptive brightness and comprising an eyepiece configured to accommodate at least one eye of a user, a digital display in a visible range positioned behind the eyepiece, an illuminator configured to illuminate the eye of the user accommodated by the eyepiece, an image sensor configured to collect an image of the eye of the user accommodated by the eyepiece, and a system configured for the automatic control of the brightness of the digital display on a basis of at least one physiological variable resulting from the image of the eye of the user.

2. The device according to claim 1, wherein the automatic control system comprises a module configured to detect and to measure a pupil diameter of the eye of the user on an image of the eye of the user, and/or a module configured to detect a condition and a stress level of the user comprising a module configured to recover a temperature of the user and/or a module configured to recover a heart rate of the user, the at least one physiological variable being selected from the pupil diameter of the eye, temperature, and heart rate of the user.

3. The device according to one claim 1, further comprising an ambient brightness sensor and/or a lighting ambience sensor and/or a user control interface so that the system for automatically controlling brightness of the digital display also uses ambient brightness and/or lighting ambience and/or a user control to automatically control said brightness of the digital display.

4. The device according to claim 1, wherein the illuminator and the image sensor operate in a near infrared spectral range.

5. The device according to claim 1, further comprising an optical system comprising a set of focusing and/or collimating lenses configured to guide light from the digital display and from the illuminator to the eye of the user and from the eye of the user to the image sensor, the optical system further comprising a dichroic filter.

6. The device according to claim 5, wherein the optical system further comprises a free-form optical element comprising the dichroic filter and a set of lenses.

7. The device according to claim 1, further comprising a user eye proximity sensor configured to operate the image display device when the eye of the user is in proximity.

8. The device according to claim 1, wherein the brightness automatic control system further comprises a colorimetry control module.

9. The device according to claim 1, wherein the automatic control system comprises a module configured to control operating parameters of the illuminator and of the image sensor on a basis of the image acquired from the eye of the user.

10. A method for adapting brightness of a display device according to claim 1, the method comprising the steps of:
acquiring an image of the eye of the user;
measuring an initial pupil diameter of the eye of the user from the image of the eye of the user and defining an initial brightness setpoint for the digital display;
adjusting brightness of the digital display with the initial brightness setpoint;
acquiring a series of images of the eye of the user;
measuring pupil diameter of the eye of the user for each image of the series of; and
adjusting brightness of the digital display on a basis of a course of the measurement of the pupil diameter of the eye of the user.
